(19) United States
(12) Patent Application Publication
(10) Pub. No.: US 2005/0112295 A1
(43) Pub. Date: May 26, 2005

(54) Method to produce microlayer thermostable materials

(76) Inventor: Mikola Grechanyuk, Kyiv (UA)

Correspondence Address: Eugene C. Rzucidlo;Greenberg Traurit, LLP, 22nd Floor, 885 Third Avenue, New York, NY, 10022, US

(21) Appl. No.: 10/744,344

(22) Filed: Dec. 23, 2003

(30) Foreign Application Priority Data
Sep. 23, 2003 (CH) 01622/03

(51) Int. Cl. H05B 3/00

(52) U.S. Cl. 427/592; 427/402

(57) ABSTRACT

A method of obtaining micro-laminate materials is proposed including consecutive deposition of materials of the layers on heated substrates, noted for that with a view to provide for continuousness of the layers in the thickness range of 0.1 to 1 μm at temperatures higher than 0.3 of the melting temperature (° C.) of the material of the least refractory layer at the layers boundary, transition boundaries made of materials of alternating layers are formed with the thickness in range of 0.001 to 0.05 μm with smooth concentration transition from the material of one layer to the material of another layer. At the same time the distance to the surface on which condensation is carried out shall be 0.55-0.8 of the distance between the centers of the crucibles from which the source materials are evaporated, whereas the distance between the centers of the crucibles from which the source materials are evaporated shall be 0.55-0.8 of the diameter of the substrate on which the condensation is carried out. The rotation speed of the substrate in relative units shall be 3-5 times more than the total rate of deposition of the vapor flow. The level of roughness of the substrate on which the condensation is carried out shall be not more than 0.63 R_{A}.

### FIELD OF THE INVENTION

The invention relates to the field of making composites with particular physical and mechanical characteristics in vacuum and may be used in a process of designing and creating special heat-resistant materials which are used, for example, for protecting shuttle spaceships, gas turbine motor blades of the new generation, creating coatings protecting products against oxidation at high temperatures, special electric-contact materials etc.

### BACKGROUND OF THE INVENTION

Every year more and more consideration is given to composite materials which consist of components with contrasting physical and mechanical characteristics. Depending on the form of the reinforcing phase the reinforced materials might be broken down into two large classes: fibrous and laminate (multi-layer) materials.

The laminate materials have a number of advantages compared to the fibrous ones, and first of all in respect of the possibility of controlling physical and mechanical properties, namely [1]:
1. When reinforcement is carried out using fibers, it is difficult to create an outer surface of the product as desired, and at the same time it is well known that the state and properties of the outer layers play the decisive part in what concerns the behavior of materials under load. Furthermore, by changing the order of alteration and the thickness of layers it is possible to vary the mechanical properties of the laminate materials under different types of load;
2. With the same volume part of the reinforcing phase the laminate materials provide for greater uniformity of deformation compared to the fibrous materials;
3. The technology of producing laminate materials is simpler than that of the fibrous materials and better known.

Industrial laminate composite materials are obtained in various ways, the main of which are combining strips, plates, sheets, foils of different metals by hot rolling, pouring liquid metals on solid plates with the subsequent rolling of the bars, explosive welding, soldering with solid solder, directional eutectic crystallization. The detailed description of the methods as well as of some physical and mechanical properties of laminate materials is given in a number of general reviews and monographs [1-6].

Eutectic heat-resistant compositions of the laminate type are more and more frequently used for manufacturing important parts of modern aircraft motors [6-8].

These materials have a number of advantages compared to one-layer ones; for example, they are stronger, more heat-resistant, they have better impact strength etc [7].

In most cases the layer thickness of the fibrous materials is 3-4 degrees more than the average grain size.

Of extreme importance for the development of modern technologies are the laminate materials where the grain size is comparable to the thickness of alternating layers or even less. In the case of such materials the strength limit may reach the lower limit of the theoretical strength of a metal [9]. Such laminate (multi-layer) materials are often referred to in technical literature as micro-laminate materials (MLM) [10,11].

Extensive research of micro-laminate materials on the basis of Cu, Pb, Sn, Cr, Fe, Ni, Mg, Au, Ag, C, Al₂O₃ with the layer thickness equaling 0.1 μm or less, obtained by dragging a wire bunch, rolling a package of foil has been carried out by V. S. Kopan [11]. He has demonstrated that one of the main factors of the programmed control of the properties of micro-laminate composite materials (MLCM) is the layer thickness. As a rule, with diminishing thickness the micro-strength, strength, elasticity and fatigue limits, deformation-induced thermal electromotive forces, electric resistance, coercive force, continuousness and cracking resistance are increasing.

The electron-ray technology gives practically unlimited opportunities to design micro-laminate materials.

Improvement in the methods and techniques of condensation of materials in vacuum, and first of all creation of powerful electron-ray evaporators and magnetron systems allows to begin to create new materials with different types of structure and thickness varying on a large scale.

At present, two classes of micro-laminate materials obtained by deposition of substances in vacuum could be singled out with a certain degree of conventionality:
a). Micro-laminate condensates (MLC) in thickness of 0.1-10 μm [10, 12-16]. The surface structure of the boundary between the layers made of different materials is similar to a large angle boundary between the grains in polycrystals;
b). Micro-laminated condensates with ultra-thin layers (from 6-8×10⁻¹⁰ to 6-8×10⁻⁸ m). Depending on the structure of the materials of the alternating layers the atomic planes conjugation of crystal lattices of the adjacent layers takes place along the coherent boundary [17,18]. Or a whole system of atomic planes is formed. [19,20]

The technique of evaporation and condensation of metal and non-metal materials in vacuum allows to implement two characteristic approaches in respect of forming a structure of micro-laminate condensates:
1. Carrying out condensation at comparatively low temperatures and, as a result, obtaining condensates with high density of crystal lattice imperfections in each layer.
2. Obtaining micro-layer condensates with a sufficiently balanced structure using the method of condensation at temperatures more than 0.3 of the melting temperature (° C.).

The first researches of micro-laminate condensates deposited using the first method were carried out in 1964-66 at Kharkov Polytechnic Institute under the guidance of L. S. Palatnic [21,22]. Patterns of structural changes and physical and mechanical properties of the condensed micro-laminate materials of the said type have been summarized by A. I. Illinsky [13,23]. The main research has been carried out with respect to Cu/Cr, Ni/Si condensates (MLC) with little cubic content of reinforcing layers (up to 10%) the thickness being not more than 0.1 μm. The total thickness of the layers of the studied MLCs did not exceed 50-100 μm. As in case of micro-layer materials obtained by traditional processing methods, there was a considerable increase in the strength of the MLC when the thickness of the component layers was reduced. It has been shown that this dimensional effect is caused mainly by the influence of the inter-phase surfaces. As shown in [13,23], it is possible by changing the total area of the inter-phase surfaces to double the strength, as demonstrated for the case of a Cu/Cr MLC.

The micro-layer compositions considered here preserve the stability of their structure and the high level of mechanical characteristics as long as the temperature does not exceed 400-500° C. In case of higher temperatures the continuousness of the alternating layers is broken (they fall to separate blocks, fragments and formations with typical heterophase structures). The structure and the properties of micro-laminate condensed materials with the thickness of alternating layers (components) exceeding 0.1 μm is researched to a much lesser extent. There are just isolated data on this question in a few sources concerning the Cu/Fe [12], Ag/Ni [24], Cu/Cr [25] MLCs precipitated at substrate temperatures that do not exceed 300° C.

The classification of the micro-laminated materials precipitated in vacuum given above and the concise review of the development level reached in this mostly important sphere show that only a small part of model MLCs deposited at comparatively low substrate temperatures (less than 300° C.) is researched.

The inventor of the present invention has carried out extensive research of micro-laminate condensed materials obtained at substrate temperatures in the range of 500-1000° C. Micro-laminate materials of the Fe/Cu, Cr/Cu, Ni/Cu, Mo/Cu, NiCrAlY/NiCrAlY—Al₂O₃, NiCrAlY/NiCrAlY—(ZrO₂+Y₂O₃), Ti/TiAl, Ti₃Al/TiAl, Ti4V6Al/TiAl type and others have been researched. The micro-laminate materials were 250×350×0.5-1.5 mm sheet blanks with alternating layers in thickness of 0.1 to 30 μm, from which specimens were then cut out for mechanical testing and physical and mechanical research. The inventor has summarized the results of this research in [26].

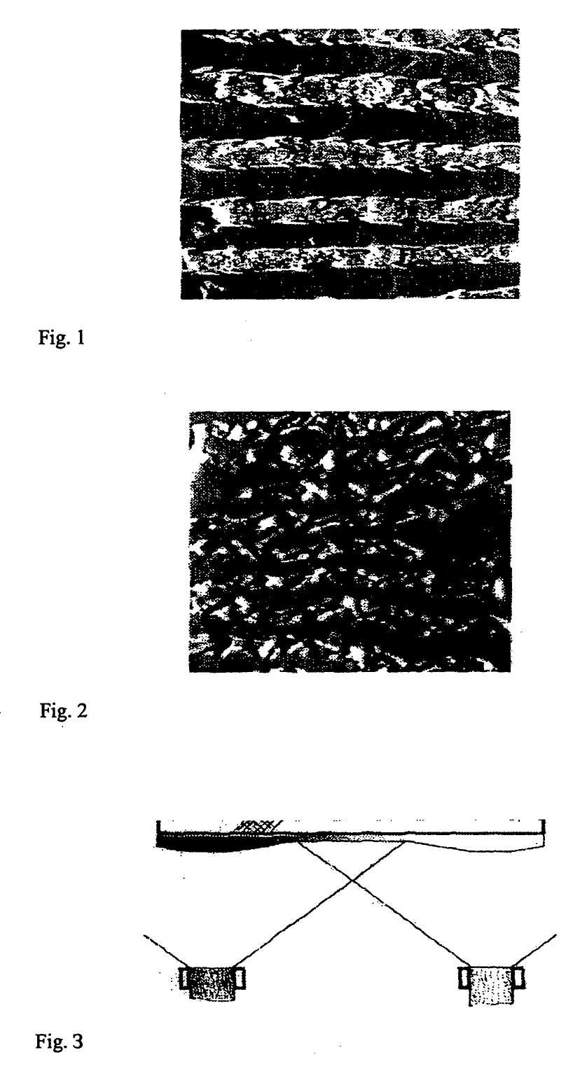

The nearest to the present invention from the technical point of view are the Fe/Cu, Cr/Cu and Ni/Cu model compositions precipitated at substrate temperatures ≈0.45 of the melting temperature of the (° C.) of the least refractory layer; it is shown that by proper choosing of the materials for alternating layers and their thickness it is possible to obtain structures with high stability, with the strength and plasticity regulated in wide range, low high-temperature creep compared to the creep speed of separate layers, low thermal conductivity compared to the thermal conductivity of separate layers. Generally the strength limit σ_{B} and the fluidity limit σ₀₂ of the studied micro-laminate materials may exceed 1.5-4 times the analogous values σ_{B} and σ₀₂ of the materials of the separate layers in case of the thickness of the alternating layers being less than 2 μm. The relative elongation of the MLC tends to decrease and comes close to zero value in case of the thickness of the alternating layers being less than 1 μm. The structure, phase composition and the physical and mechanical properties of the NiCrAlY/NiCrAlY—Al₂O₃, NiCrAlY/NiCrAlY—(ZrO₂+Y₂O₃) new class of metal/cermet condensed materials have been studied in the 0.2 . . . 25 μm thickness range with 0 to 50 mass %. content of oxide in the cermet layers. It has been established that the main factor determining the change in properties of the micro-laminate materials is the oxide content in cermet micro-layers. When the oxide concentration is 0.5-4% and the micro-layers thickness is 1-25 μm the strength and plasticity values of the micro-laminated materials are by 10-20% more than in case of matrix alloys, and the heat-resistance—by 5-30%. The typical structure of such materials is shown in FIG. 1.

In case of all types of MLCs studied that have been deposited at temperatures more than 0.3 of the melting temperature (° C.) of the least refractory layer disintegration of layers occurs when the thickness of a single micro-layer is less than 1 μm (see FIG. 2).

Thus, a general conclusion can be drawn that there is a lack of information in the technical literature concerning the micro-laminate materials with the thickness of layers less than 1 μm obtained at deposition temperatures more than 0.3 of the melting temperature (° C.) of the least refractory layer.

At the same time it should be expected that in case of micro-laminate materials with 0.1 to 1 μm layer thickness obtained at temperatures ensuring forming of equiaxed structures (the substrate temperature ≦0.3 of the melting temperature (° C.) of the least refractory layer) it is possible, as in case of other types of MLCs considered above, to vary in a large range the physical and mechanical structure-sensitive properties by corresponding choice of the layers components. It is logical to assume that the micro-laminated materials obtained at high substrate temperatures will differ from the well-known ones by increased level of the thermal stability of the structure. Correspondingly, the materials condensed at high substrate temperatures may be indispensable when designing special heat-resistant alloys for aviation, electronic and electrotechnical industries and coatings for special use.

As mentioned above, attempts of obtaining micro-laminated materials with the thickness of the alternating layers less than 0.5-1 μm at substrate temperatures exceeding 400-500° C. are connected with some difficulty due to layers disintegration.

### SUMMARY OF THE INVENTION

The inventor of the present invention has managed for the first time to implement the idea of obtaining micro-laminate materials with the layers thickness in the range of 0.1 to 1 μm obtained at substrate temperatures not less than 0.3 of the melting temperature (° C.) of the material of the least refractory layer. The stability of the structure of alternating layers is reached by forming a transitional boundary made of materials of alternating layers with 0.001 to 0.005 μm in thickness with smooth concentration transition from the material of one layer to the material of another layer. The additional stability is reached owing to programmed oxidation of the components forming micro-layers. The concentration of oxides at the transitional area does not exceed 3-5%. At the same time with creation of oxides there is the process of forming carbides when the carbide-forming components of the layers interact with the oil vapor from the vacuum pumps, the concentration of which does not exceed 2-4%.

It has been established by the inventor that creation of a stable micro-laminate structure is possible only under fulfillment of the following conditions:
1. The distance to the surface at which the condensation takes place shall be 0.55-0.8 of the distance between the centers of the crucibles from which the material is evaporated;
2. The distance between the centers of the crucibles shall be 0.55-0.8 of the diameter of the substrate at which the condensation is carried out;
3. The rotation speed of the substrate in relative units shall be 3-5 times more than the total deposition rate of the vapor flow (for example, when the total deposition rate of the copper and molybdenum vapor flow is 10 μm/min, the rotation speed of the substrate shall be at least 30 rpm).
4. The level of roughness of the substrate at which the material is condensed shall be not more than 0.63 R_{A}.
5. The temperature of the substrate at which the material is condensed shall be in the range of 0.3-0.8 of the melting temperature (° C.) of the of the least refractory metal (alloy) that is evaporated.

### DETAILED DESCRIPTION OF THE INVENTION

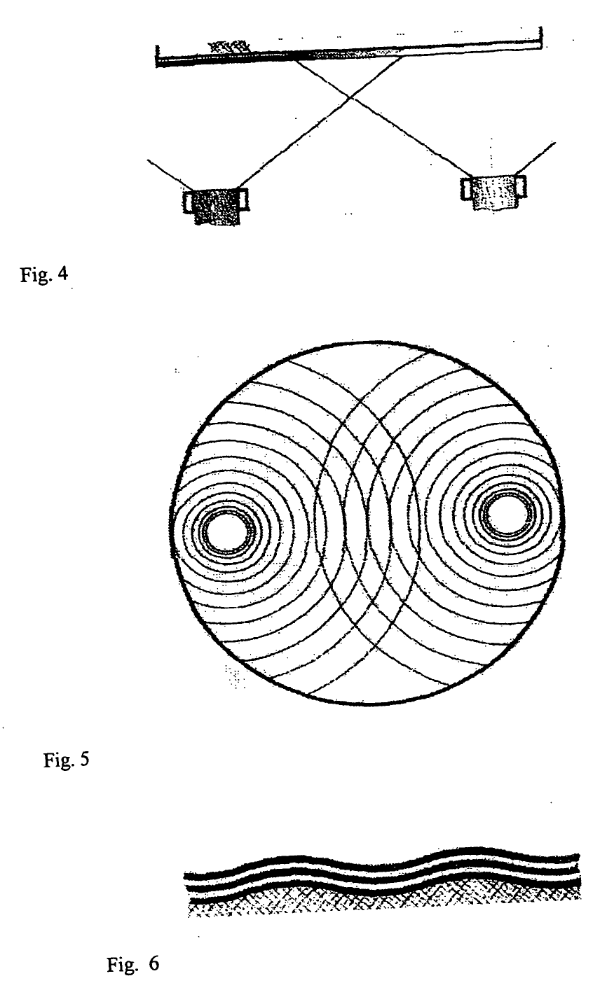

FIGS. 3, 4, 5 show the distribution of atoms (molecules) that are evaporated (for example, those of copper and molybdenum) at the substrate at which the condensation is carried out calculated according to the cosine distribution rule proposed by Knudsen [27]. This rule which has been verified by many researchers describes with sufficient accuracy the distribution of atoms (molecules) at the substrate in case of evaporation of a substance from a point source.

FIGS. 3, 4, 5 clearly show that at given geometrical layout of the crucibles (which are considered in calculations to be point sources of evaporation) and the substrate there are distribution areas where almost pure evaporated materials can be obtained. The distribution density of atoms (molecules) of copper and molybdenum decreases monotonously with increasing diameter of the substrate. And, as a result, at a separate area of the substrate the copper and molybdenum vapor flows get mixed and a transitional layer is formed between the components forming the condensate. FIGS. 3, 4, 5 also clearly show that there are areas of minimal distribution density of atoms (molecules) of copper and molybdenum. In these areas forming of oxides and carbides of the evaporated materials is most probable in consequence of their interaction with oil vapors (carbon) of the vacuum pumps and the residual atmosphere in the working chamber (oxygen). It has been established experimentally that the total content of oxides, carbides and other refractory compounds in the condensed materials does not exceed 5-8 mass %. The type of created compounds and their number depend on the art of the materials being evaporated, the vacuum degree, the speed of exhaustion, the speed of inleakage of residual gases from the atmosphere. The presence of disperse parts of oxides and carbides from 100 to 200 Å (0.0001-0.0002 μm) in size—mainly in the transitional boundary between the layers—promotes thermal stability of the created layers and slows down the diffusive processes at the boundary of the layers which bring about their disintegration.

Creation of a micro-laminate structure is impossible if the substrate is fixed (FIG. 3) as the areas where the vapor flows of the evaporated materials get mixed remain practically unchanged. Under such conditions a condensate is formed in which there is a transition from practically 100% of the component A to 100% of the component B with two-phase (heterophase) components area. The breadth of the two-phase (heterophase) area depends on the geometrical layout of the sources of evaporated materials and the technological parameters of deposition.

The picture is quite different when the substrate is turning (FIGS. 4, 5). In this case the peripheral areas of the substrate, when turning, are exposed to the vapor flow of the evaporated component A, the vapor flow of the components (A+B) and (B+A) and, furthermore, the vapor flow of the component B. The vapor flows of the components A→A+B→B+A→B are superimposed on each other. It is clear that the thickness of alternating micro-layers will depend on the technological parameters of the procedure of obtaining the material: the rate of evaporation of the corresponding materials, the rotation speed of the substrate. Increasing or decreasing the rotation speed of the substrate, we will inevitably bring about corresponding increasing or decreasing of the thickness of alternating A and B components layers.

Regulated changing of the thickness of the alternating layers may be achieved not only by varying the rotation speed of the substrate, but also by regulating the evaporation rate of the components. In this case the thickness of the alternating layers of A and B components may be easily changed along the height of the condensate being formed. This is of great importance, for example, when a condensate is formed where the A component is metal (alloy), and the B component is oxide, metallic compound or their mixture.

If there are three or more crucibles, it is possible to include disperse additions of refractory phase into one of the layers or both of them for increasing their physical and mechanical characteristics and the thermal stability of the structure on the whole. The cited examples clearly show that implementation of this method gives practically unlimited opportunities in respect of creating fundamentally new materials with a given complex of physical and mechanical characteristics.

As mentioned above, obtaining materials with such micro-laminate structure is possible only in case of fulfillment of certain technological conditions.

The first of them is that the distance to the surface at which the vapor flow is condensed shall be 0.55-0.8 of the distance between the centers of the crucibles from which the evaporation is carried out. The said limitation is clearly illustrated by FIG. 5. According to the cosine rule of the vapor flow distribution, in case of reducing the distance from the substrate to the crucibles the interposition area of the vapor flows will diminish. If the thickness of this area decreases or such an area does not exist at all, it will be impossible to obtain layer structures with the thickness of alternating layers less than 0.5, μm. On the other hand, increasing the distance between the crucibles from which the evaporation is carried out and the substrate is economically inexpedient as the vapor utilization factor dramatically drops (this factor shows the ratio of the quantity of the vapor flow condensed on the substrate to the total quantity of vapor precipitated in the working chamber of the installation). For example, in case of condensation of copper and molybdenum vapor at a substrate having 1000 mm in diameter when the distance between the crucibles is 650 mm and the distance to the substrate is 450 mm, the vapor utilization factor will be 0.58-0.62.

The second condition is a crucial one: the distance between the centers of the crucibles shall be 0.55-0.8 of the diameter of the substrate at which the condensation is carried out. In case of reduction of the distance between the crucibles the interposition (mixing) area of the vapor flows will increase. The thickness of the transitional boundary will increase proportionally and the thickness of the layers will decrease which will lead to a decrease in the stability of the layer structure or even to its complete disappearance.

On the other hand, if the distance between the centers of the crucibles is more than 0.8 of the diameter of the substrate, creation of a transitional boundary between the layers will become practically impossible owing to the absence of interposition (mixing) of the vapor flows. The absence of a stable transitional boundary will as well bring about disintegration of the layers.

The third condition—the rotation speed of the substrate in relative units shall be 3-5 times more than the total deposition rate of the vapor. This condition originates in the first two. In case of the geometrical layout of the crucibles being as stated above, if the relative speeds are comparable—the rotation speed of the substrate (for example, 10 rpm) and the total vapor flow deposition rate (10 μm/min)—the thickness of each of the alternating layers will be approximately 1 μm if the deposition rates of the components A and B are approximately the same, that is, about ten times less than the relative values of the rotation speed of the substrate and the deposition rate of the components A and B.

It is clear that for reduction of the thickness of the alternating micro-layers it is necessary to: a) increase the rotation speed of the substrate and, b) reduce the total rate of deposition of the vapor flow. The former is undoubtedly more paying as decreasing the deposition rate is economically inexpedient.

The fourth condition—the roughness grade of the substrate at which condensation takes place shall be not less than 0.63 μm.

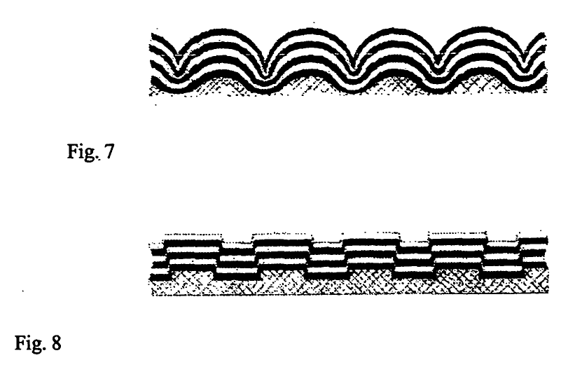

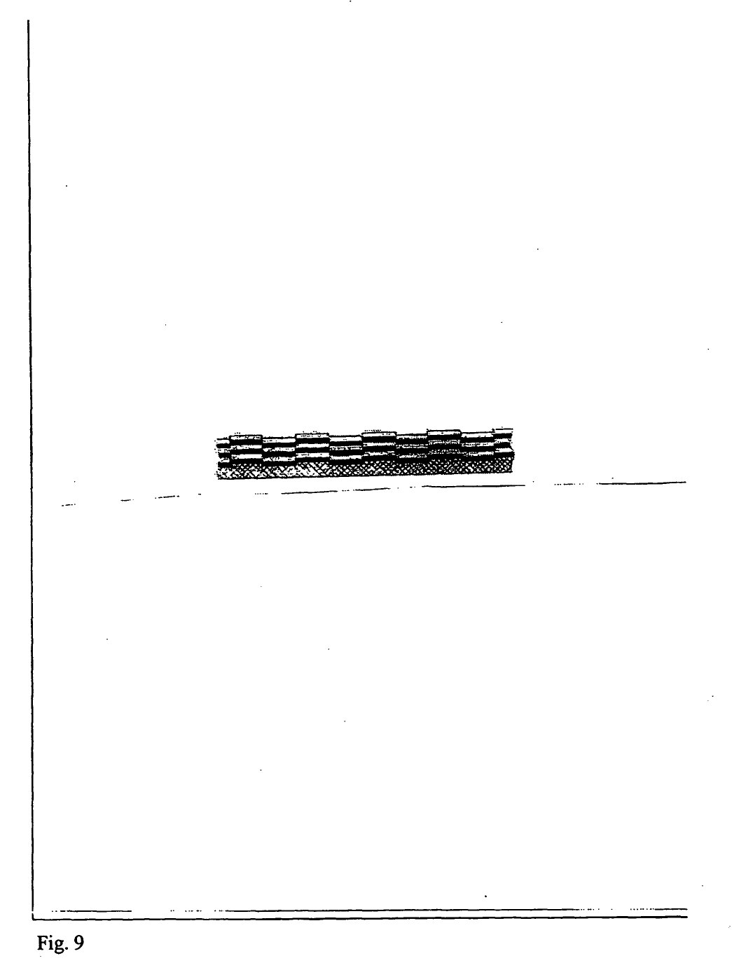

In FIGS. 6, 7, 8, 9 the dotted lines show the different types of roughness which could be obtained in the process of preparation of the substrate on which condensation takes place, from undulating one as in FIGS. 6, 7 to a ribbed one as in FIGS. 8, 9.

As the concentrated vapor flow reproduces quite accurately the profile of the surface of the substrate at which condensation takes place, the type of roughness strongly influences the stability of the alternating micro-layers and the mechanical characteristics of the condensed material on the whole. Ideally, there should be quite even smooth surfaces, which is possible practically, but inexpedient from the economical point of view in case of wide industrial manufacturing of such materials.

The most acceptable is the surface treatment shown in FIG. 6. In this case the undulation of the layers of A and B components (correspondingly the light and dark lines in FIG. 6) practically does not effect the mechanical characteristics of the micro-laminated materials. If the level of undulation is increasing and its form changes from a domed to a ribbed one (see FIG. 7), it may bring about possible imperfection of the laminated structure (intermittence of layers and appearance of tension concentrators in cavities areas, which will ultimately lead to deterioration of the mechanical characteristics of the material).

In case of a ribbed type roughness of the substrate surface, if the height of the ribs is comparable to the thickness of a single micro-layer, the micro-laminate material can not be formed at all without creating discontinuities (intermittence) in layers (see FIGS. 8, 9)

In this case only fragments of alternating micro-layers can be observed.

Furthermore, in case of condensation at the side surfaces of the ribs at angles close to 180° (FIG. 8) or equal to 180° (FIG. 9) the condensate that is being formed has a powder form. As a rule, this leads to exfoliation (cracking) of the condensate along thickness. So, this form of roughness is inadmissible at all in respect of forming micro-laminate materials from the vapor phase.

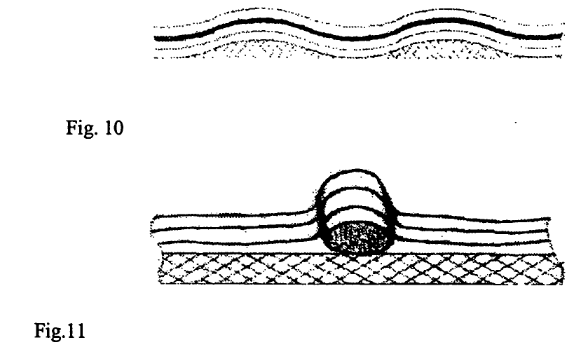

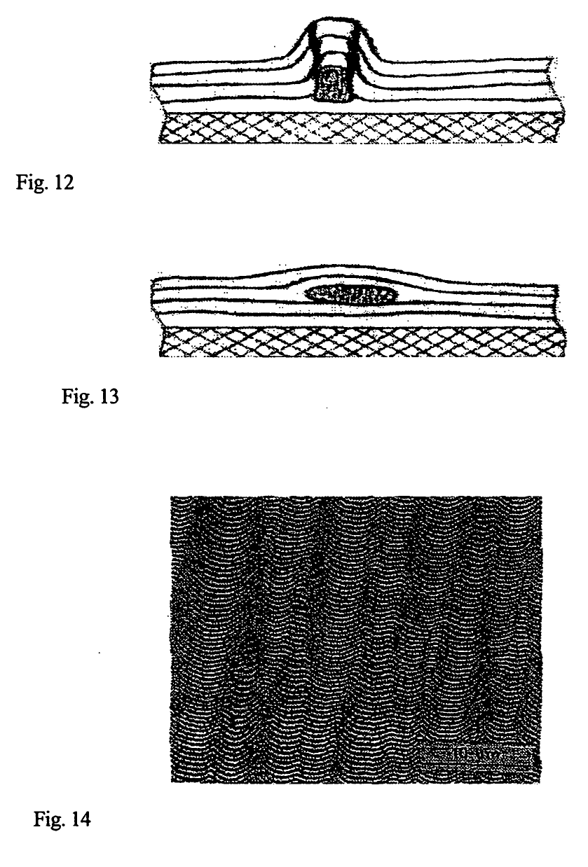

The physical and mechanical characteristics of the condensates are considerably influenced by the structural defects of the material which are caused by: a) possible short-time turning off of the high voltage in the process of evaporation of the source materials (FIG. 10); b) drop transfer in the process of forming the separating layer (FIG. 11), drop transfer of the source materials (FIGS. 12, 13).

The most dangerous are the defects that are formed at initial stages, that is during formation of the separating pre-layer (FIG. 11) and during the first minutes of formation of the micro-laminated material itself (FIG. 12). At the micro-drops formed during deposition of the separating layer (for example, in the process of evaporation of CaF₂) or at the micro-drops formed at the substrate at the initial moment of evaporation of the source materials (such an effect is observed in case of oxidation of a liquid form of the evaporated material, presence of non-metal additions in the source (evaporating) bars, partial dissociation of oxides, carbides, borides during their evaporation) needle-form sticks are formed (FIGS. 10, 11) that are practically not connected with the basic material throughout the height of the condensate. The said sticks contribute to rapid deterioration of the material even under minimal mechanical loads.

The possible inter-layer exfoliation of the condensed material may also occur in case of a short-time turning off of the accelerating voltage. In this case in consequence of temporary interruption of the vapor flow getting to the substrate oxidation of the upper layers of the condensate occurs as well as formation of carbides oxides due to presence of residual atmosphere and oil vapor in the working chamber of the installation. In FIG. 10 the described exfoliation is shown by the dark line.

The formation of a separating oxi-carbide (boride) layer during a short-time turning off of the accelerating voltage may also occur due to films of oxide, carbide and boride that were present in the bar, which films cover the surface of the liquid in the bath.

When the accelerating voltage is turned on again, an explosive evaporation of the surface film occurs from the liquid metal mirror to a certain area of the substrate. That is why the inter-layer exfoliation occurs as a rule not at the whole perimeter of the condensate but only in certain areas.

So the level of roughness, the form of the micro-irregularities at the surface as well as the purity of the source (evaporating) bars considerably influence the formation of micro-layer structures and the physical and mechanical characteristics of the condensate on the whole.

And, finally, the fifth condition—the temperature of the substrate on which the condensation is carried out shall be in the range of 0.3-0.8 of the melting temperature (° C.) of the least refractory metal (alloy) that is evaporated.

Research of the structure of condensates of some pure metals and oxides in the thickness of 0.3-2 mm obtained by means of electron-ray evaporation has enabled the authors of [28] to propose a three-zone model of formation of thick condensates. The first zone is the low-temperature zone for temperatures varying from less than the room temperature to some boundary temperature T₁ which equals approximately to 0.3 of the melting temperature (° C.) of the condensed material. At temperatures less than T₁ the surfaces of the condensates have a dome form. There are cone-shaped crystallites in the cross-section of the condensate. The adjacent crystallites join without a strongly pronounced inter-crystallite boundary. There are micropores within the crystallites, especially in border zones. The condensates obtained at temperatures less than T₁ are characterized by low strength and plasticity. So, in our example, when we form condensed micro-laminate materials with improved physical and mechanical characteristics, the temperature of the substrate shall be not less than 0.3 of the melting temperature (° C.) of the evaporated substance.

The upper limit of heating the substrate—0.8 of the melting temperature (° C.) of the condensed material—is called forth by the fact that at higher precipitation temperatures there is a considerable crystal growing. In the process the strength of the material decreases considerably with simultaneous increasing of its plasticity which is not always desirable and necessary from the point of view of further use of the material.

Basing on the established rules of formation of the structure of micro-laminated thermostable materials, the author has studied a whole line of such materials, and particularly Cu—Mo, Fe—Cu, Cr—Cu.

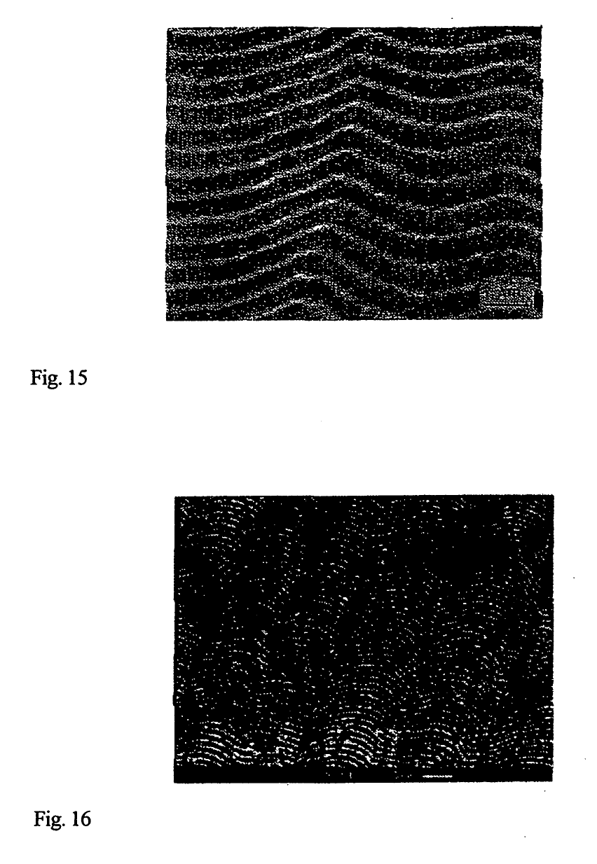

The typical structures of such micro-laminated condensed materials, namely the Cu—Mo composites, are shown in FIGS. 14, 15, 16. The condensates in the form of sheets having 800 to 1000 mm in diameter and 0.5 to 4 mm in thickness are obtained using an industrial electron-ray installation of the UE-189 type. The substrate on which the condensation is carried out is preliminary heated to the temperature of 650±20° C. For easier separation of the condensed material from the substrate it has been preliminarily coated with a thin (10 . . . 15 μm) separating layer of calcium fluoride (CaF₂). In the FIGS. 14, 15, 16 the corresponding dark layers are the layers of copper and the light ones—those of molybdenum. The changing profile of the alternating layers indicates changing roughness of the substrate. In this case smooth undulation of layers is observed without abrupt changes (saliences/cavities) able to bring to a considerable deterioration of mechanical characteristics. The average thickness of the copper and molybdenum layers shown in FIG. 14 is 0.3 and 0.2 μm correspondingly, in FIG. 15—0.4-0.5 and 0.15-0.2 μm. The alternating copper and molybdenum layers do not have perceptible fractures and discontinuities. The laminated structure of Cu—Mo condensates remains intact even after vacuum annealing at a temperature of 900° C. during 3 hours (FIG. 16).

Only in separate areas of the condensate layer discontinuities caused by the beginning of their disintegration are observed. Taking into account that the copper melting temperature is 1083.4° C. [29], it must be admitted that these materials are characterized by exceptionally high thermal stability. Qualitatively similar structures have also been obtained for Fe—Cu and Cr—Cu condensates. Table 1 shows some physical and mechanical properties of the researched materials in initial state and after vacuum annealing at 900° C. during 3 hours.

Analysis of the results given in the Table 1 shows that the micro-laminated Cu/Mo materials, although they contain more than 30 mass % of a relatively weak and plastic component (copper), exceed in respect of their mechanical strength the source components at room temperatures: the copper—almost 4 times, the molybdenum—almost 2 times. In respect of the MLC strength the Cu/Mo materials exceed in strength the pure copper and molybdenum nearly 6.5 and 1.5 times correspondingly. The vacuum annealing of the condensates at 900° C. during 3 hours reduces the strength by approximately 25-30% and simultaneously increases the plasticity 1.6-1.9 times. Vacuum annealing practically does not influence the density and the specific electrical resistivity of the condensates.

It is interesting to point out the fact that the strength value for the Cu/Mo MLCs at the temperature of testing equalling to 650° C. are comparable to the strength of the copper at the room temperature.

Table 2 shows some physical and mechanical properties of the Fe/Cu, Ni/Cu and Cr/Cu micro-laminated materials at room temperature. As in case of the Cu/Mo condensates, they also are characterized by substancial increase in strength and solidity compared to the strength and solidity of the initial components.

Table 2—Physical and Mechanical Properties of the Fe/Cu, Ni/Cu and Cr/Cu Micro-Laminated Materials at Room Temperature.

So, the results given above and their analysis show the great possibilities of the claimed method of designing fundamentally new micro-laminate materials.

| | | Thickness of the | Mechanical properties: | | | | | |
|---|---|---|---|---|---|---|---|---|
| | | alternating micro- | σ_{B}, | σ₀₂, | | | | Specific electric |
| No | Materials: | layers, mm | MΠa | MΠa | δ,% | Microstrength, MPa | Density, g/sm³ | resistivity |
| 1 | Fe/Cu | Cu-0.12 | 620 | 618 | 0.2 | 2200 | | |
| | | Fe-0.12 | | | | | | |
| 2 | Ni/Cu | Cu-0.3 | 530 | 519 | 0.3 | 2300 | | |
| | | Ni-0.3 | | | | | | |
| 3 | Cr/Cu | Cu-0.2 | 500 | 480 | 0.1 | 1700 | | |
| | | Cr-0.2 | | | | | | |
| 4 | Ni | — | 343-561 | 78-205 | 40-42 | 588-784 HB | 8.9 | 0.069 |
| 5 | Cr | — | 294-343 | 313 | 0 | 686-1275 | 7.1 | 0.132 |

1. A method of making micro-laminate thermostable materials comprising successively depositing layers of materials on a substrate in vacuum, the improvement wherein the deposition is carry out so as to ensure the continuousness of the layers in the thickness range from 0.1 to 1 μm at substrate temperatures not less than 0.3 of the melting temperature (° C.) of the material of the least refractory layer at the layers boundary and forming, a transitional boundary is formed of the material of alternating layers with the thickness from 0.001 to 0.005 μm and smooth concentration transition from the material of one layer to the material of another layer.

2. The method of the claim 1 wherein the distance to the surface at which condensation takes place is about 0.55-0.8 of the distance between centers of crucibles from which the source materials are evaporated.

3. The method of the claim 2 wherein the distance between the centers of the crucibles from which the source materials are evaporated is about 0.55-0.8 of the diameter of the substrate at which condensation takes place.

4. The method of any one of claims 1, 2, or 3 comprising rotating the substrate at a rotation speed measured in relative units of about 3-5 times more than the total rate of deposition of the vapor flow.

5. The method of any one of claims 1, 2, 3, or 4 wherein the level of roughness of the substrate at which condensation takes place is not more than 0.63 R_{A}.
